(19) United States
(12) Patent Application Publication
(10) Pub. No.: US 2021/0316904 A1
(43) Pub. Date: Oct. 14, 2021

(54) ENVELOPE WINDOW SHAPE AND INDICIA COORDINATED WITH GREETING CARD THEME

(71) Applicant: Hallmark Cards, Incorporated, Kansas City, MO (US)

(72) Inventor: Robert Dale Kim, Leawood, KS (US)

(21) Appl. No.: 16/846,045

(22) Filed: Apr. 10, 2020

(51) Int. Cl. B65D 27/04; B42D 15/08

(52) U.S. Cl. CPC B65D 27/04; B65D 27/06; B42D 15/08

(57) ABSTRACT

A coordinated greeting card and envelope are provided. The greeting card includes a theme and the envelope contains a window that cooperates with and supplements the theme. A message and/or artwork is provided on panels of the greeting card to define the theme. The envelope may also include indicia cooperating with the window and the theme (e.g., message or artwork) of the greeting card. The envelope may also include indicia to show areas to include a recipient or sender's address. A user may see a portion of the theme of the greeting card through the window of the envelope. The envelope may also have a message to guide the user to orient the greeting card placed in the envelope such that the message or artwork on the greeting card is displayed upright in the window on the envelope. The window may also include a thin and transparent plastic film to protect the contents of the envelope.

### SUMMARY

This Summary is provided to introduce a selection of concepts in a simplified form that are further described below in the Detailed Description. This Summary is not intended to identify key features or essential features of the claimed subject matter, nor is it intended to be used in isolation as an aid in determining the scope of the claimed subject matter.

Embodiments of the present invention are directed to a combination greeting card and envelope, each having an open configuration and a closed configuration. The combination greeting card and envelope generally comprises a greeting card with a theme and an envelope with a window shape and indicia coordinated with the theme of the greeting card, such that decorative card content of the greeting card (that is consistent with the theme) is visible through the envelope window when the greeting card is inside the envelope.

### BRIEF DESCRIPTION OF THE DRAWINGS

Embodiments of the invention are described in detail below with reference to the attached drawing figures, wherein:

FIG. 1 is a front elevation view of a greeting card in a closed position, in accordance with an embodiment of the present invention;

FIG. 2 is a front elevation view of an envelope in an open position, in accordance with an embodiment of the present invention;

FIG. 3 is a front elevation view of the greeting card of FIG. 1 partially received in the envelope of FIG. 2;

FIG. 4 is a front elevation view of the greeting card of FIG. 1 fully received in the envelope of FIG. 2, but with the envelope in a closed position, in accordance with an embodiment of the present invention;

FIG. 5 is a rear elevation view of the envelope of FIG. 2, in accordance with an embodiment of the present invention;

FIG. 6 is a front elevation view of a greeting card and envelope, with the greeting card fully outside of the envelope, in accordance with another embodiment of the present invention; and

FIG. 7 is a front elevation view of the greeting card and envelope of FIG. 6 with the greeting card fully received inside the envelope, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or a combination of steps similar to the ones described in this document, in conjunction with other present or future technologies.

The invention described herein relates to a greeting card with a theme and an envelope with a window and indicia coordinated with the theme of the greeting card. The greeting card contains decorative card content indicative of the theme. In one embodiment, the greeting card includes a panel having a first subpanel and a second subpanel. The first subpanel and the second subpanel may be separated by a fold in the panel. In another aspect, a greeting card can take the form of a single panel, similar to a postcard. In yet another embodiment, the greeting card can have more than two subpanels. The greeting card may have decorative card content on the interior and exterior sides of each panel or subpanel. When the greeting card is placed in the envelope, the orientation of the greeting card determines which the portion of the decorative card content is viewed through the window in the envelope.

The envelope is capable of receiving and enclosing the greeting card. The envelope may comprise a panel having one or more subpanels. The subpanels may be separated by a fold in the panel. Each subpanel may include indicia or markings coordinated with the theme of the greeting card. The envelope has a window in the front subpanel where a portion of the greeting card inside is viewable. The shape of the window on the envelope may complement and be tied to the theme and decorative card content of the greeting card. In some embodiments, indicia disposed about the window may also be coordinated with the theme of the greeting card or the window and provide context as to the theme of the greeting card inside envelope. In one embodiment, the window may be covered with a transparent or translucent film to protect the contents of the envelope and to make the decorative card content of the greeting card inside visible.

In one embodiment, the exterior side of the envelope's front subpanel includes indicia indicating where the contact information (e.g., name, mailing address) of the recipient may be placed, which is in an area separate from the or adjacent to the window. In some embodiments, the exterior side of the envelope's back panel also includes indicia for a sender to include contact information (e.g., name, mailing address). The interior side of the back panel of the envelope (e.g., a surface of a flap) may also include a message or note to alert the sender to orient the greeting card so that the decorative card content of the greeting card aligns with the envelope window for display to the recipient. In some embodiments, the message may be placed on other subpanels.

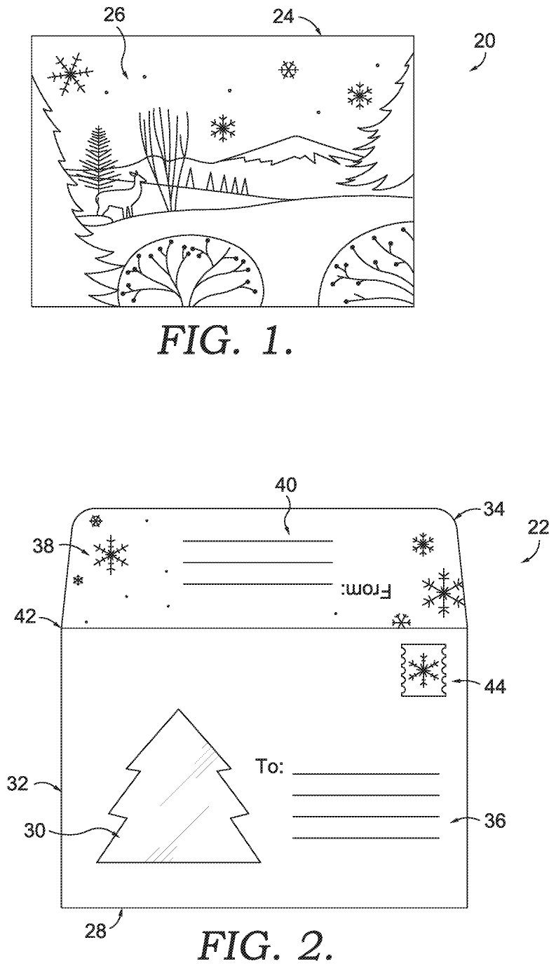

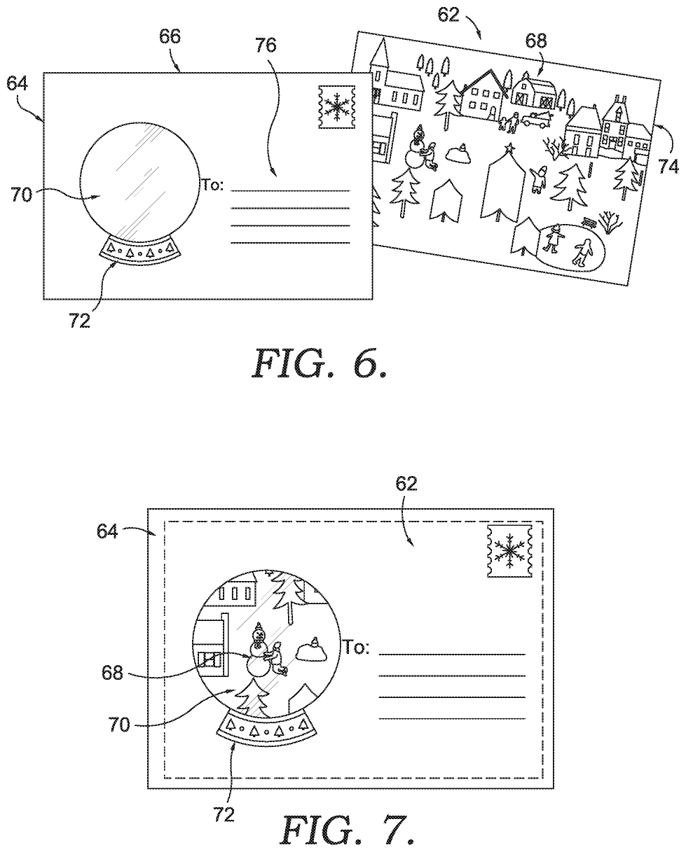

Referring now to the drawings in more detail, wherein like reference characters designate like parts throughout the different views, and initially to FIGS. 1-5, a greeting card 20 and an envelope 22 with a coordinated theme is depicted, in accordance with a first embodiment of the present invention. The greeting card 20 includes a panel 24 and a decorative card content 26. The envelope 22 includes a panel 28 having a window 30 therein with a shape related to the theme and decorative card content 26 of the greeting card 20. In some embodiments, the envelope 22 may further include indicia (as shown in FIGS. 6 and 7) disposed about the window 30 that is tied to the theme of the greeting card and compliments or coordinates with the shape of the window 30.

The panel 24 of the greeting card 20 may include an interior-facing side (not shown) and an exterior-facing side. Both the interior and exterior-facing sides can include decorative card content 26, including artwork and/or a message. The interior-facing sides (not shown) are only visible when the card is in an unfolded (i.e., open) position. The exterior-facing sides may be visible in either the folded or the unfolded position depending on card orientation.

In some embodiments, the panel 24 of greeting card 20 includes multiple subpanels (not shown) that contain decorative card content 26 on either or both interior- and exterior-facing panels and are separated by one or more folds (not shown). The interior-facing side of the subpanels are likewise visible when the greeting card is in an unfolded position (i.e., open) and the exterior-facing side of the subpanels are visible depending on the orientation of the greeting card in either the folded or unfolded positions. In other embodiments the greeting card can take the form of a single panel, similar to a postcard. In yet other embodiments the greeting card may have more than two subpanels.

Each of the greeting card 20 and its subpanels may have a folded position and an unfolded position. The folded position of the greeting card 20 may have an interior portion and an exterior portion. The interior portion of the greeting card 20 may be obscured from view when the greeting card 20 is in the folded position (i.e., closed) and may be exposed when the greeting card 20 is in the unfolded position (i.e., open). The exterior portion of the greeting card 20 may be viewable, in both the folded or unfolded positions, based on the orientation of the greeting card.

The decorative card content 26 may be affixed to the panel 24 and its subpanels. In some embodiments, the decorative card content 26 is printed onto the panel 24 and its subpanels. The decorative card content 26 on the exterior portion of the greeting card may be displayed through the window 30 of the envelope 22 depending on the orientation of the greeting card 20.

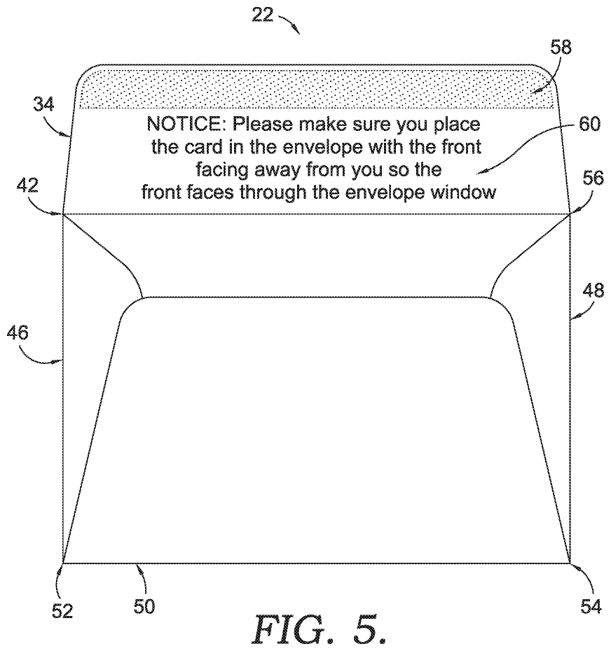

The panel 28 of the envelope 22 may include two or more subpanels and at least one fold. For example, the panel 28 may include a first subpanel 32 and a second subpanel 34 separated from one another by a fold 42. Some embodiments of the panel 28 may include additional subpanels. The second subpanel 34 can include an interior-facing side (as shown in FIG. 5) and an exterior-facing side (as shown in FIGS. 2 and 3). Both the interior- and exterior-facing sides can include decorative envelope content, including artwork and/or writings or other indicia. The interior-facing side of second subpanel 34 is only visible when the envelope 22 is in an unfolded position. The exterior-facing side of second subpanel 34 may be visible in either the folded or the unfolded position, depending on orientation of the envelope 22.

Each of the envelope 22 and the panel 28 may have a folded position and an unfolded position. In some embodiments, the unfolded position of the envelope 22 (show in FIGS. 2 and 3) may correspond to the unfolded position of panel 28 (shown in FIGS. 2 and 3). The envelope 22 is in a folded position when the second subpanel 34, which may also be referred to as a flap, is folded across fold 42 and encloses the contents within the envelope. The folded position of the envelope 22 may have an interior portion and an exterior portion. The interior portion of the envelope 22 may be hidden from view when the envelope is in the folded position (i.e., closed), while the exterior portion of envelope 22 is visible, depending on orientation of the envelope 22. Likewise, the interior portion of envelope 22 may be exposed when the envelope 22 is in the unfolded position (i.e., open), as shown in FIG. 5.

The subpanel 32 of envelope 22 may include one or more windows, such as window 30, for viewing a portion of the exterior portion of the greeting card 20 when the greeting card 20 is in the folded position and fully inside the envelope 22. The window 30 of envelope 22 is an area of the envelope through which an exterior portion of the greeting card 20 (such as part of the decorative card content 26) may be viewed depending on the orientation of the greeting card 20 when inserted in the envelope 22. The window 30 is generally a hole that is die-cut through the paper of the first subpanel 32. In the present invention, the shape of window 30 is made to coordinate with the decorative card content 26 (and theme) of the greeting card 20 contained within the envelope 22. In some embodiments, the shape of the window 30 is cut into the envelope 22 by a die-cut manufacturing process. In some embodiments, the window 30 may be covered by a thin, transparent or translucent film on either the interior-facing or exterior-facing side of the first subpanel 32 to prevent damage to the contents inside the envelope 22. The film may be made of plastic. In some embodiments, the window 30 does not display contact information (e.g., name, mailing address) of the recipient.

In one embodiment, an area 44 of the first subpanel 32 includes indicia showing a location designated for postage on the front side of the envelope 22. Some embodiments of the envelope 22 may include indicia 36 in an area on the first subpanel 32 to notify the sender to include the mailing address of the recipient. This can be particularly helpful if the window is in a location that is generally where one would normally place recipient address information. In one embodiment, the envelope 22 includes indicia (as shown in FIGS. 6 and 7) disposed on the exterior of the first subpanel 32 about the window 30 that is coordinated with the shape of the window 30, as well as with the decorative card content 26. In one embodiment, decorative envelope content (not shown) is affixed to the subpanel 32 of envelope 22 by printing the decorative envelope content.

In the illustrated embodiments, the second subpanel 34 is separated from the first subpanel 32 by the fold 42. The second subpanel 34 includes an interior-facing side and an exterior-facing side. The interior-facing side is only visible when the envelope is in an unfolded position, as shown in FIG. 5. The exterior-facing side may be visible in either the folded or the unfolded position, depending on envelope orientation. In some embodiments (e.g., as illustrated in FIG. 2), the second subpanel 34 includes decorative envelope content 38 on the exterior-facing side that complements the decorative card content 26 of the greeting card 20. The second subpanel 34 may also include indicia 40 on the exterior-facing side notifying the sender to include return contact information (e.g., name, mailing address) of the sender.

In one embodiment, the decorative envelope content 38 is affixed to either the interior-facing or the exterior-facing sides of the second subpanel 34 of the envelope 22 via printing. Contact information for the recipient (on the front side) and for the sender (on the back side) may also be printed (in addition to the indicia 36 and indicia 40) on the envelope 22. In some embodiments, the second subpanel 34 is a flap or sealing subpanel that securely encloses the contents of the envelope 22 when the second subpanel 34 is in a folded (i.e., closed) position.

The decorative card content 26 of the greeting card 20 and the shape of the window 30 on the envelope 22 can be coordinated to promote the same theme. For example, in the embodiment depicted in FIGS. 1-5, the decorative card content 26 of the greeting card 20 is Christmas-themed with a winter landscape. The shape of the window 30 is coordinated with decorative card content 26 by being cut in the shape of a Christmas tree. Likewise, the greeting card 20 and the envelope 22 can use the same decorative themes, such as the same text colors, images, and fonts. The same background color can be used on both the greeting card 20 and the envelope 22.

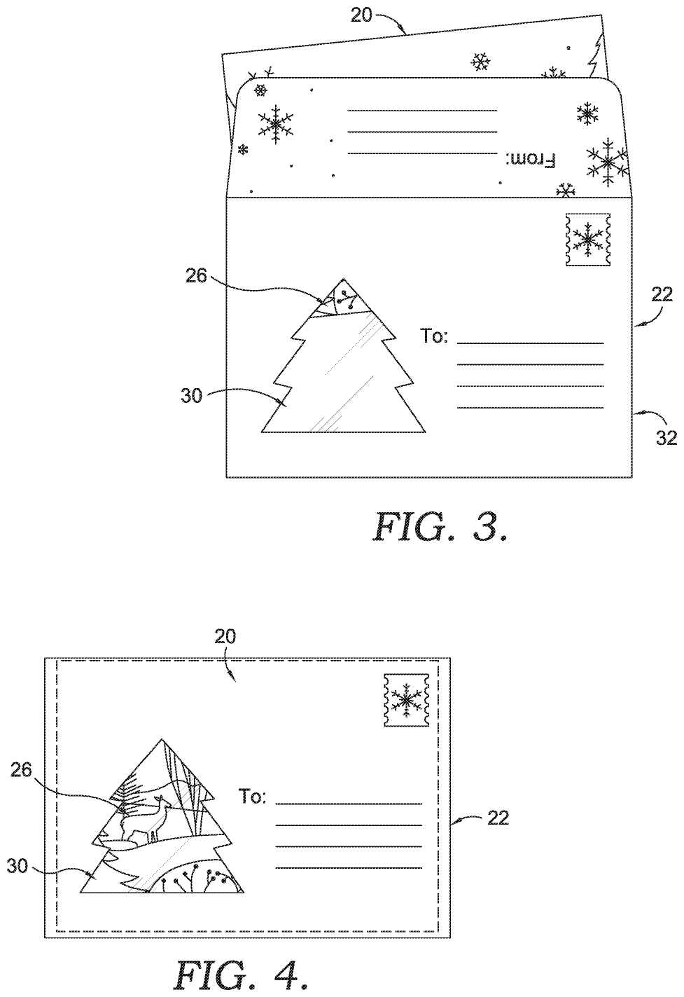

Turning now to FIGS. 3 and 4, a front elevation view of the greeting card 20 in a closed position and placed, either partially or fully, respectively, within an envelope 22 is shown. In general, FIG. 3 illustrates the greeting card 20 partially inserted within the envelope 22, where the envelope 22 is in an open position, while FIG. 4 illustrates the greeting card 20 when it has been fully inserted within the envelope 22 and the envelope is in a closed position. In FIG. 3, the greeting card 20 is partially concealed by the envelope 22 and a portion of the decorative card content 26 shows through the window 30. The greeting card 20 is oriented, when placed inside the envelope, with the decorative card content 26 on the front exterior of the greeting card 20 facing outwardly toward the front of the envelope 22. The greeting card 20, when closed, is slightly smaller in height and width than that of the envelope 22, as illustrated by the dashed lines in FIG. 4, to allow the greeting card 20 to fit inside the envelope 22.

In FIG. 4, with the greeting card 20 fully received within the envelope 22, the entire window 30 provides the recipient with a view of a portion of the decorative card content 26 that coordinates with the shape of window 30. For example, the window 30 in the shape of a Christmas tree complements the winter scene decorative card content 26 viewed through the window 30. In this manner, the window 30 gives the recipient a small hint or sample as to the theme of the greeting card 20 contained therein before they even open the envelope. This small “taste” of what is to come once the envelope 22 is opened heightens the recipient's anticipation as they open the envelope, thereby increasing the emotional experience and overall satisfaction with the greeting card 20. The shape of the window 30, being coordinated with the theme of the decorative card content 26 that shows through the window 30, further enhances the anticipation and satisfaction of the recipient. As shown in the illustrated embodiment, the greeting card 20 is oriented to show the decorative card content 26 through the window 30 in an upright orientation (e.g., the deer is standing upright, the ground is near the bottom of the viewable area, and the trees are growing upwards from the ground, in the window 30).

Turning now to FIG. 5, a rear elevation view of the envelope 22 in an open position is shown. The envelope 22 includes subpanels 46, 48, 50, as well as the second subpanel 34. Subpanels 46, 48, and 50 are subpanels that are separated by folds 52, 54, and 56, respectively. In some embodiments, the exterior-facing sides of the subpanels 46, 48, and 50 may include decorative envelope content (not shown—shown on subpanel 34 in FIGS. 2 and 3) that coordinates with and complements the decorative card content 26. The decorative envelope content (not shown) may be affixed, including by printing, onto the subpanels.

The interior-facing side of subpanel 34 also includes an adhesive 58 that, when activated (e.g., by moistening or removing a cover), adheres the second subpanel 34 to the exterior surface of subpanel 50 when subpanel 34 is folded over fold 42 to securely enclose the contents of the envelope 22. The interior-facing side of the second subpanel 34 includes instructions 60 that notify the sender that the greeting card 20 should be oriented and inserted into the envelope 22 such that the decorative card content 26 of the greeting card 20 is displayed in window 30. The content in the example in the illustrated embodiment reads “NOTICE: Please make sure you place the card in the envelope with the front facing away from you so the front faces through the envelope window.” As can be seen, the notice alerts the sender to orient the greeting card 20 with respect to window 30. In one embodiment, if the decorative card content 26 of greeting card 20 is on the front of the greeting card 20 with the un-folded end of the greeting card 20 facing downward, then the greeting card 20 should be placed into the envelope 22 with the front facing the side of the envelope with the window 30. For example, in reference to the orientation in FIG. 4, the instructions 60 alert the sender to orient the greeting card 20, when inserting it into the envelope 22, to have the decorative card content 26 facing the front of the envelope 22 with the decorative card content 26 in an upright position (e.g., deer standing up and not displayed upside down).

Turning to FIGS. 6 and 7, a second embodiment of the present invention is depicted. Here, a greeting card 62 and an envelope 64 may include many of the same features as the greeting card 20 and envelope 22, respectively (discussed above in reference to FIGS. 1-5). For example, the greeting card 62 may include a panel 74 having multiple subpanels each separated by a fold. Likewise, the envelope 64 may include a panel 66 with multiple subpanels each separated by a fold.

Referring to FIG. 6, the panel 74 of the greeting card 62 includes decorative card content 68. The envelope 64 also includes a window 70 with nearby coordinated indicia 72. The envelope 64, similar to the envelope 22, may include indicia 76, separate from window 70, for alerting the sender to provide contact information (e.g., name, mailing address) for a recipient.

As can be seen, the window 70 and the indicia 72 of the envelope 64 coordinate with the decorative card content 68 (and theme) of greeting card 62 as well as the shape of the window 70. For example, the circular window 70 is flanked by indicia 72 below the circle. The indicia 72 is adjacent (i.e., disposed about) the bottom of the circle and appears to be a base holding the circle upright and resting flat on a surface. The indicia 72 on the envelope 64 (i.e., an illustration of a base holding the circle upright), coupled with the decorative card content 68 displayed through the circular window 70 (i.e., a snowy scene), indicates that the window 70 and indicia 72 are coordinated to depict a snow globe.

In one embodiment, the indicia 72 providing context for the window 70 may be farther away from (i.e., not adjacent to) the window. Likewise, the indicia 72 can use the same decorative themes, such as the same text colors, images, and fonts as those of the greeting card 62 and envelope 64. The same background color can be used on the indicia 72 as well as the greeting card 62 and envelope 64. Similarly, indicia (not shown) could be placed on the exterior of the front of the envelope 22 of the first embodiment. For example, an illustration of a tree trunk could be placed on the front of the envelope 22 below the tree-shaped cutout of the window 30. This indicia would cooperate with the shape of the window 30 to further enhance the perception of a Christmas tree, which, along with the portion of the decorative card content 26 of the greeting card 20 showing through the window 30, helps convey to the recipient a small portion of the theme of the greeting card 20 received therein, thereby enticing them to open the envelope 22 with eager anticipation.

As shown in FIG. 7, the window 70 on the envelope 64 is coordinated with the decorative card content 68 of greeting card 62. A portion of the decorative card content 68 is visible to the user through the window 70. The window 70 is covered with a transparent film to prevent damage to the greeting card 62 inside and allow the recipient to view a portion of decorative card content 68. As can be seen, the decorative card content 68 on greeting card 62 is oriented, when placed within the envelope 64, such that the snowman and the child building the snowman are both upright. Likewise, the tree and buildings in the portion of the viewable decorative card content 68 are similarly oriented upright, versus upside-down. With the greeting card 62 fully inside the envelope 64 (as shown by the dotted lines), the decorative card content 68, in an upright position, is displayed through window 70 and coordinates with both the shape of the window 70 and the indicia 72 on the front of the envelope 64.

Many variations can be made to the illustrated embodiments of the present invention without departing from the scope of the present invention. Such modifications are within the scope of the present invention.

From the foregoing it will be seen that this invention is one well adapted to attain all ends and objects hereinabove set forth together with the other advantages which are clear following the complete disclosure above and which are inherent to the methods and apparatuses described herein. It will be understood that certain features and sub-combinations are of utility and may be employed without reference to other features and su-combinations. This is contemplated by and is within the scope of the invention and claims.

Since many possible embodiments may be made of the invention without departing from the scope thereof, it is to be understood that all matter herein set forth or shown in the accompanying drawings is to be interpreted as illustrative of applications of the principles of this invention, and not in a limiting sense.

The invention claimed is:

1. A coordinated combination greeting card and envelope article, the combination article comprising:
a greeting card with a card content indicative of a theme; and
an envelope configured to receive the greeting card, the envelope having:
a first subpanel, wherein the first subpanel comprises a window in a shape coordinated with the theme, and wherein the window is configured to display a portion of the card content when the greeting card is inside the envelope, and
a second subpanel, wherein the second subpanel comprises instructions indicative of an orientation of the greeting card in the envelope, and wherein the first subpanel and the second subpanel are separated by a fold.

2. The article of claim 1, the envelope further comprising indicia disposed about the window that is coordinated with the theme and is associated with the shape of the window.

3. The article of claim 1, wherein the window is covered with a transparent, thin film.

4. The article of claim 1, wherein the first subpanel comprises indicia for placement of contact information of a recipient.

5. The article of claim 1, wherein the instructions are located on an interior-facing side of the second subpanel, wherein the interior-facing side of the second subpanel is concealed when the envelope is in a closed position.

6. The article of claim 5, wherein an exterior-facing side of the second subpanel comprises indicia for placement of contact information of a sender.

7. The article of claim 5, wherein the interior-facing side of the second subpanel comprises an adhesive to secure closure of the envelope when the second subpanel is folded.

8. The article of claim 1, wherein the window is formed using a die-cut manufacturing process.

9. A coordinated combination greeting card and envelope article, the combination article comprising:
a greeting card indicative of a theme; and
an envelope configured to receive the greeting card, the envelope having:
a window in a shape coordinated with the theme, and
indicia at least partially disposed about the window and coordinated with the theme.

10. The article of claim 9, the envelope further comprises a plurality of subpanels affixed with decorative envelope content indicative of the theme.

11. The article of claim 9, wherein the window is covered by a transparent, thin film.

12. The article of claim 9, wherein the envelope further comprises a first subpanel on the front of the envelope, the first subpanel having indicia for placement of a name and address of a recipient.

13. The article of claim 9, wherein the envelope further comprises a second subpanel which, when the envelope is in a closed position is on the back of the envelope, the second subpanel having an interior-facing side comprising instructions indicative of an orientation of the greeting card in the envelope, wherein the interior-facing side of the second subpanel is concealed when the envelope is in a closed position.

14. The article of claim 13, wherein an exterior-facing side of the second subpanel comprises indicia for placement of a name and mailing address of a sender.

15. The article of claim 13, wherein the interior-facing side of the second subpanel comprises an adhesive to secure closure of the envelope when the second subpanel is folded.

16. The article of claim 9, wherein the window is formed using a die-cut manufacturing process.

17. A combination foldable envelope and greeting card article, the combination article comprising:
a greeting card with a card content indicative of a theme; and
an envelope configured to receive the greeting card, the envelope having a window in a shape coordinated with the theme and wherein a portion of the theme of the greeting card is visible through the window when the greeting card is received in the envelope.

18. The article of claim 17, the envelope further comprising a first subpanel, the first subpanel having indicia for placement of a name and address of a recipient.

19. The article of claim 17, the envelope further comprising a second subpanel, the second subpanel having instructions indicative of an orientation of the greeting card in the envelope.

20. The article of claim 19, wherein the second subpanel further comprises indicia for placement of a name and mailing address of a sender.
